(19) United States
(12) Patent Application Publication
(10) Pub. No.: US 2026/0234479 A1
(43) Pub. Date: Aug. 13, 2026

(54) APPARATUS AND PROCESS FOR INJECTING CATALYSTS INTO A COUNTER-CURRENT DOWNER FOR FLUIDIZED CATALYTIC CRACKING

(71) Applicants: Saudi Arabian Oil Company, Dhahran (SA); King Abdullah University of Science and Technology, Thuwal (SA)

(72) Inventors: Mengmeng Cui, Thuwal (SA); Pedro Castano, Thuwal (SA); Khalid Ali Almajnouni, Jeddah (SA); Lujain R. Alfilfil, Thuwal (SA); Nikolaos Papagiannis, Thuwal (SA); Jorge Gascon Sabate, Thuwal (SA)

(73) Assignees: Saudi Arabian Oil Company, Dhahran (SA); King Abdullah University of Science and Technology, Thuwal (SA)

(21) Appl. No.: 19/082,974

(22) Filed: Mar. 18, 2025

Related U.S. Application Data
(63) Continuation of application No. PCT/GR2025/050002, filed on Feb. 11, 2025.

(51) Int. Cl. C10G 11/18; B01J 8/00; B01J 8/18

(52) U.S. Cl. CPC C10G 11/18; B01J 8/004; B01J 8/1827; B01J 8/1881; B01J 2208/00752; C10G 2400/20

(57) ABSTRACT

Methods for processing hydrocarbons may include introducing a hydrocarbon feed stream into a reactor vessel through a hydrocarbon feed inlet proximate a bottom end of the reactor vessel, introducing a catalyst into the reactor vessel through a catalyst injection system proximate a top end of the reactor vessel, and contacting the hydrocarbon feed stream with the catalyst in a reaction zone of the reactor vessel in a counter-current orientation to produce a cracked hydrocarbon stream and a spent catalyst. The catalyst injection system includes a plurality of injector nozzles, one or more of which has a downwards elevation angle Φ of at most 60 degrees between a nozzle axis A_{N} of the injector nozzle and a longitudinal axis A_{L} of the reactor vessel.

### CROSS-REFERENCE TO RELATED APPLICATIONS

The present application is a bypass continuation of and claims priority to International Application No. PCT/GR2025/050002, filed Feb. 11, 2025, the contents of which are incorporated by reference herein in their entirety.

### TECHNICAL FIELD

Embodiments of the present disclosure generally relate to systems and methods for processing hydrocarbons and, more specifically, to fluidized catalytic cracking and apparatuses for such.

### BACKGROUND

Olefins, including ethylene, propylene, and butylene, are basic intermediates used by a large portion of the petrochemical industry. Traditionally, olefins are produced by thermal cracking of petroleum fractions such as naphtha, kerosene, or gas oil. However, olefins may also be produced through refinery fluidized catalytic cracking (FCC) processes. The production of olefins such as ethylene, propene, and butylene has attracted increased attention as purified olefin streams are considered the building blocks for various polymers and chemicals. The production of light olefins depends on several process variables, such as the feed type, operating conditions, and the type of catalyst. To address the increasing demand for light olefins, there is a need for improved methods for processing hydrocarbons to produce olefins.

### SUMMARY

Described herein are fluidized catalytic cracking methods and systems for processing hydrocarbons. In particular, the methods and systems described herein utilize a counter-current downer reactor with a catalyst injection system having a plurality of injector nozzles configured to inject catalyst particles into the reactor vessel. One or more of the injector nozzles is oriented to have a downwards elevation angle with respect to a longitudinal axis of the reactor vessel. Further, one or more of the injector nozzles has an inner diameter that decreases over at least some portion of the injector nozzle along a catalyst flow direction of the injector nozzle. It has been discovered that, according to one or more embodiments described herein, the utilization of such catalyst injection systems achieves quick acceleration and uniform distribution of catalyst particles for enhanced gas-solid mixing. Accordingly, the utilization of the catalyst injection systems described herein may enhance reactant contact with active catalyst sites for improved conversion and selectivity, offer flexibility for adjusting system operation, and provide process intensification opportunities with relatively low capital investment.

According to one or more embodiments, a method for processing hydrocarbons comprises introducing a hydrocarbon feed stream into a reactor vessel through a hydrocarbon feed inlet proximate a bottom end of the reactor vessel, introducing a catalyst into the reactor vessel through a catalyst injection system proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone, wherein the catalyst injection system comprises a plurality of injector nozzles, and wherein one or more injector nozzles of the plurality of injector nozzles comprises: a nozzle axis A_{N}; a nozzle tip defining a nozzle end plane P_{E} that is normal to the nozzle axis A_{N}; a first inner diameter ID₁ at a first distance D₁ from the nozzle end plane P_{E} along the nozzle axis A_{N}; a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁; and a downwards elevation angle Φ of at most 60 degrees between the nozzle axis A_{N} and a longitudinal axis A_{L} of the reactor vessel.

According to one or more embodiments, a fluidized catalytic cracking (FCC) system comprises: a reactor vessel comprising an elongated reaction tube having a substantially vertical orientation, a top end, and a bottom end; a hydrocarbon feed inlet proximate the bottom end of the reactor vessel; a catalyst injection system proximate the top end of the reactor vessel, wherein the catalyst injection system comprises a plurality of injector nozzles, and wherein one or more of the injector nozzles of the plurality of injector nozzles comprises: a nozzle axis A_{N}; a nozzle tip defining a nozzle end plane P_{E} that is normal to the nozzle axis A_{N}; a first inner diameter ID₁ at a first distance D₁ from the nozzle end plane P_{E} along the nozzle axis A_{N}; a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁; and a downwards elevation angle Φ of at most 60 degrees between the nozzle axis A_{N} and a longitudinal axis A_{L} of the reactor vessel.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a reactor system having a batch reactor configuration, according to one or more embodiments disclosed herein;

FIG. 2 schematically depicts a reactor system having a continuous reactor configuration, according to one or more embodiments disclosed herein;

FIG. 3 schematically depicts a side view of catalyst injector nozzles coupled to a reactor vessel, according to one or more embodiments disclosed herein;

FIG. 4 schematically depicts a top view of catalyst injector nozzles coupled to a reactor vessel wherein the injector nozzles are perpendicularly oriented, according to one or more embodiments disclosed herein;

FIG. 5 schematically depicts a top view of catalyst injector nozzles coupled to a reactor vessel wherein the injector nozzles are tangentially oriented, according to one or more embodiments disclosed herein;

FIG. 6 schematically depicts an injector nozzle coupled to a reactor vessel wherein the injector nozzle has a tangential orientation, according to one or more embodiments disclosed herein;

FIG. 7 schematically depicts an injector nozzle coupled to a reactor vessel wherein the injector nozzle has an angled orientation, according to one or more embodiments disclosed herein;

FIG. 8 schematically depicts a side view of an injector nozzle, according to one or more embodiments disclosed herein;

FIG. 9 schematically depicts a side view of an injector nozzle, according to one or more embodiments disclosed herein;

FIG. 10 schematically depicts a side view of an injector nozzle, according to one or more embodiments disclosed herein;

FIG. 11 schematically depicts a side view of an injector nozzle having a plurality of carrier gas injectors coupled thereto, according to one or more embodiments disclosed herein;

FIG. 12 schematically depicts a side view of an injector nozzle having a carrier gas distribution chamber, according to one or more embodiments disclosed herein;

FIG. 13 schematically depicts a catalyst distributor plate of an injector nozzle, according to one or more embodiments disclosed herein;

FIG. 14A depicts data related to simulated time-averaged solid holdup at different heights of the reactor vessel for a particle injection velocity of 1.0 m/s, according to an example of the present disclosure;

FIG. 14B depicts data related to simulated time-averaged solid holdup at different heights of the reactor vessel for a particle injection velocity of 1.5 m/s, according to an example of the present disclosure;

FIG. 14C depicts data related to simulated time-averaged solid holdup at different heights of the reactor vessel for a particle injection velocity of 1.8 m/s, according to an example of the present disclosure;

FIG. 14D depicts data related to simulated time-averaged solid holdup at different heights of the reactor vessel for a particle injection velocity of 2.0 m/s, according to an example of the present disclosure;

FIG. 15A depicts data related to simulated time-averaged particle velocity in the vertical direction at different heights of the reactor vessel for a particle injection velocity of 1.0 m/s, according to an example of the present disclosure;

FIG. 15B depicts data related to simulated time-averaged particle velocity in the vertical direction at different heights of the reactor vessel for a particle injection velocity of 1.5 m/s, according to an example of the present disclosure;

FIG. 15C depicts data related to simulated time-averaged particle velocity in the vertical direction at different heights of the reactor vessel for a particle injection velocity of 1.8 m/s, according to an example of the present disclosure;

FIG. 15D depicts data related to simulated time-averaged particle velocity in the vertical direction at different heights of the reactor vessel for a particle injection velocity of 2.0 m/s, according to an example of the present disclosure;

FIG. 16 graphically depicts data related to simulated time- and area-averaged solid holdup at different heights of the reactor vessel for five different simulations wherein the particle injection velocity was varied, according to an example of the present disclosure;

FIG. 17 graphically depicts data related to simulated time- and area-averaged particle velocity in the vertical direction at different heights of the reactor vessel for five different simulations wherein the particle injection velocity was varied, according to an example of the present disclosure;

FIG. 18A graphically depicts data related to a simulated particle residence time distribution for a particle injection velocity of 1.0 m/s, according to an example of the present disclosure;

FIG. 18B graphically depicts data related to a simulated particle residence time distribution for a particle injection velocity of 1.5 m/s, according to an example of the present disclosure;

FIG. 18C graphically depicts data related to a simulated particle residence time distribution for a particle injection velocity of 1.8 m/s, according to an example of the present disclosure;

FIG. 18D graphically depicts data related to a simulated particle residence time distribution for a particle injection velocity of 2.0 m/s, according to an example of the present disclosure;

FIG. 19 graphically depicts data related to simulated time- and area-averaged solid holdup at different heights of the reactor vessel for two different simulations wherein the elevation angle of catalyst injectors was varied, according to an example of the present disclosure; and

FIG. 20 graphically depicts data related to simulated time- and area-averaged particle velocity in the vertical direction at different heights of the reactor vessel for two different simulations wherein the elevation angle of catalyst injectors was varied, according to an example of the present disclosure.

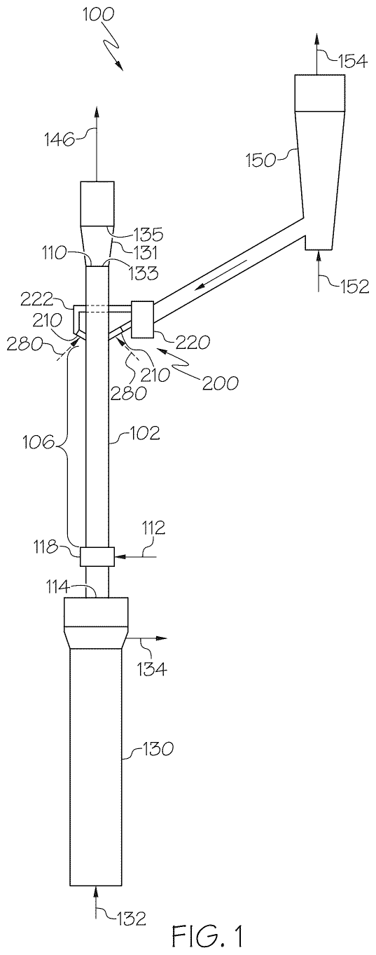

For the purpose of describing the simplified schematic illustrations and descriptions of FIGS. 1-13, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not all necessarily depicted. Accompanying components that are in cracking units, such as bleed streams, spent catalyst discharge subsystems, and catalyst replacement sub-systems are also not shown. It should be understood that these components are within the spirit and scope of the present embodiments disclosed. It should be understood that the reactor diameter should not be inferred from the drawings and that the diameter of the reactor may be similar or different to the depiction in the drawings. Additionally, operational components, such as those described in the present disclosure, may be added to the embodiments described in this disclosure.

It should further be noted that some arrows in the drawings refer to process streams, as would be understood by those skilled in the art. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed to FCC reactors and methods of their use, and in particular catalyst injections systems used therein. FCC reactors are considered one of the central components for the conversion of bottom of the barrel hydrocarbons into lighter products including light olefins and middle distillates. FCC reactors may also be utilized to process crude oils. In a conventional FCC riser reactor, catalyst particles move with hydrocarbons in the upwards direction against gravity. As the FCC process involves successive reactions, desired products such as olefins are formed as intermediate products which may become entrained within catalyst particles. However, solids back-mixing, clustering, and radial segregation that are typical in riser reactors lead to a wide range of particle residence time distributions, which may limit the selectivity of the targeted products of petrochemicals as intermediate desired products may be further cracked to undesired by-products. Meanwhile, in co-current downer reactors, catalyst particles and hydrocarbons move downwards with gravity thus minimizing the solid back-mixing with dynamic stable clustering, thereby achieving a narrower residence time distribution which may result in higher conversion and less chance of over-cracking. However, typical solid holdup levels for co-current downers is usually less than 1%, which is generally below desired solid holdup levels for enhanced interphase heat transfer and catalytic reactions.

According to one or more embodiments, the counter-current downer configuration for an FCC reactor implements a gas upwards and solids downwards flow pattern that combines the advantages of risers and co-current downers to achieve improved solid holdup and less back mixing under high temperatures and high catalyst/feed ratios, which benefits applications requiring enhanced heat and mass transfer and controlled short residence time. Particles undergo two stages of hydrodynamic behaviors in a counter-current downer: an acceleration zone and a developed zone. The acceleration zone extends from the catalyst injection point at the top of the counter-current downer to the level where the catalyst particles reach constant velocity where the drag force exerted on the particles is balanced by gravity in the developed zone. System turbulence may occur around the acceleration zone, with unstable gas-solid interaction and pressure fluctuation. The ultra-short contact time between the hydrocarbon feed and catalysts in FCC processes for producing petrochemicals imposes stringent demands of rapid solid dispersion of the catalysts in the gas flow. Therefore, there is a need for methods and systems that shorten the acceleration time and provide for a uniform distribution of particles for enhancing gas-solid contact and improving product selectivity for the catalytic cracking of hydrocarbons to petrochemicals.

According to one or more embodiments, the methods and systems described herein utilize a counter-current downer reactor with a catalyst injection system having a plurality of injector nozzles configured to inject catalyst particles into the reactor vessel. One or more of the injector nozzles is oriented to have a downwards elevation angle with respect to a longitudinal axis of the reactor vessel. Further, one or more of the injector nozzles has an inner diameter that decreases over at least a portion of the injector nozzle along a catalyst flow direction of the injector nozzle. It has been discovered that the utilization of such catalyst injection systems achieves quick acceleration and uniform distribution of catalyst particles for enhanced gas-solid mixing. In particular, after being accelerated by injector nozzles, catalyst particles enter the reactor with initial velocities along the horizontal and vertical directions with potential vortex effects, which shortens the acceleration time, improves the gas-solid contact by maintaining high-density conditions, and offers flexibility to adjust the gas residence time. The better gas-solid contact may lead to improved conversion of feed and selectivity to the targeted products. Accordingly, the utilization of the catalyst injection systems described herein for injecting catalysts into counter-current downers may enhance reactant contact with active catalyst sites for improved conversion and selectivity. According to one or more embodiments, the systems and methods described herein also offer flexibility for adjusting system operation and provide process intensification opportunities with relatively minor capital investment.

Some embodiments of the present disclosure are directed to methods for processing hydrocarbons. The methods for processing hydrocarbons may comprise introducing a hydrocarbon feed stream into a reactor vessel (e.g., a single reactor vessel) through a hydrocarbon feed inlet proximate a bottom end of the reactor vessel, introducing a catalyst into the reactor vessel through a catalyst injection system proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone. The hydrocarbon feed stream may be contacted with the catalyst in a counter-current orientation to form a cracked hydrocarbon stream. As the hydrocarbon feed stream and the catalyst move in opposite directions, the counter-current operation provides a unique contact pattern between the catalyst and hydrocarbons that includes an initial feed cracking with partially deactivated catalysts followed by a subsequent deep cracking of intermediate molecules upon contact with fresh catalysts, which also offers high potentiality for FCC processes with petrochemicals as the targeted products such as, for example, one or more of ethylene, propylene, and butylene. This reactor configuration allows for a high catalyst/reactant ratio and an enhanced contact pattern between the catalyst and hydrocarbons with improved heat and mass transfer. Moreover, this reactor configuration reduces back-mixing and allows for a narrower residence time distribution for the catalyst and hydrocarbons, which may improve the selectivity of the targeted products. Each of these features may improve the yield of desired olefin products.

In one or more embodiments, the catalyst injection system comprises a plurality of injector nozzles, wherein one or more injector nozzles of the plurality of injector nozzles has a nozzle axis A_{N}, a nozzle tip defining a nozzle end plane P_{E} that is normal to the nozzle axis A_{N}, a first inner diameter ID₁ at a first distance D₁ from the nozzle end plane P_{E} along the nozzle axis A_{N}, and a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁. Further, one or more injector nozzles of the plurality of injector nozzles has a downwards elevation angle Φ of at most 60 degrees between the nozzle axis A_{N} and a longitudinal axis A_{L} of the reactor vessel. In one or more embodiments, each injector nozzle of the plurality of injector nozzles has a nozzle axis A_{N}, a nozzle tip defining a nozzle end plane P_{E} that is normal to the nozzle axis A_{N}, a first inner diameter ID₁ at a first distance D₁ from the nozzle end plane P_{E} along the nozzle axis A_{N}, and a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁. Further, each injector nozzle of the plurality of injector nozzles may have a downwards elevation angle Φ of at most 60 degrees between the nozzle axis A_{N} and the longitudinal axis A_{L} of the reactor vessel. It has been found that catalyst injection systems having these features may be utilized for processing hydrocarbons in counter-current downer FCC reactors to achieve a number of benefits including reduced particle acceleration time and a more uniform distribution of catalyst particles for enhanced gas-solid mixing.

The indefinite articles “a” and “an” are employed to describe elements and components of the present disclosure. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used in the present disclosure, also signifies that the modified noun may be singular or plural, unless otherwise stated in specific instances.

As used in this disclosure, passing a stream or effluent from one unit “directly” to another unit refers to passing the stream or effluent from the first unit to the second unit without passing the stream or effluent through an intervening reaction system or separation system that substantially changes the composition of the stream or effluent, such as through chemical reaction or through preferential separation of one or more constituents from the stream or effluent. Heat transfer devices, such as heat exchangers, preheaters, coolers, condensers, or other heat transfer equipment, and pressure devices, such as pumps, pressure regulators, compressors, or other pressure devices, are not considered to be intervening systems that change the composition of a stream or effluent, unless otherwise specifically stated in the present disclosure. Combining two streams or effluents together upstream of a process unit also is not considered to comprise an intervening system that changes the composition of one or both of the streams or effluents being combined. Simply dividing a stream into two streams having the same composition is also not considered to comprise an intervening system that changes the composition of the stream.

As used in this disclosure, a “reactor” refers to a vessel in which one or more chemical reactions may occur between one or more reactants optionally in the presence of one or more catalysts. For example, a reactor may include a tank or tubular reactor configured to operate as a batch reactor, a continuous reactor, or a plug flow reactor. Example reactors include fluidized bed reactors. One or more “reaction zones” may be disposed in a reactor. As used in this disclosure, a “reaction zone” refers to an area where a particular reaction takes place in a reactor.

As used in this disclosure, the term “counter-current” may be used to describe the relationship between process streams flowing in substantially opposite directions where the process streams flow past or through one another. For example, a first process stream flowing in a substantially downward direction may flow counter-current to a second process stream flowing in a substantially upward direction. The direction of the flow of a stream may be in the same direction as the superficial velocity of that stream. As used throughout the present disclosure, the term “counter-current reactor” may be used to describe reactors in which catalyst and reactants and/or products flow through a reactor in a counter-current orientation.

As described herein, “superficial velocity” refers to the velocity at which an individual phase flows through a given cross-sectional area. The net flow of a phase is used to determine superficial velocity of that phase; thus, individual particles or molecules within a phase may move in a direction different from, or even opposite to, the net flow of a phase without affecting the direction of the superficial velocity of that phase. In some embodiments, the superficial velocity of catalyst moving through the reaction zone may be in a substantially downward direction.

As used in this disclosure, a “catalyst” refers to any substance which increases the rate of a specific chemical reaction. Catalysts described in this disclosure may be utilized to promote various reactions, such as, but not limited to, cracking. As used in this disclosure, “cracking” generally refers to a chemical reaction where a molecule having carbon to carbon bonds is broken into more than one molecule by the breaking of one or more of the carbon to carbon bonds, or is converted from a compound which includes a cyclic moiety, such as a cycloalkane, cycloalkane, naphthalene, an aromatic or the like, to a compound which does not include a cyclic moiety or contains fewer cyclic moieties than prior to cracking.

As used in this disclosure, the term “spent catalyst” refers to catalyst that has been contacted with reactants at reaction conditions in a reaction zone to catalyze a chemical reaction, but has not been subsequently regenerated in a regenerator or subjected to an in-place regeneration process in the reactor following contact with the reactants. The “spent catalyst” may have coke deposited on the catalyst and may include partially coked catalyst as well as fully coked catalysts. The amount of coke deposited on the “spent catalyst” may be greater than the amount of coke remaining on the regenerated catalyst following regeneration. In some embodiments, spent catalyst may be cooler than catalyst that is injected into a reactor, but may be compositionally similar or identical to the regenerated catalyst.

As used in this disclosure, the term “regenerated catalyst” refers to catalyst that has been contacted with reactants at reaction conditions in a reaction zone to catalyze a chemical reaction and then regenerated in a regenerator or subjected to an in-place regeneration process to heat the catalyst to a greater temperature, oxidize and remove at least a portion of the coke from the catalyst to restore at least a portion of the catalytic activity of the catalyst, or both. The “regenerated catalyst” may have less coke, a greater temperature, or both compared to spent catalyst and may have greater catalytic activity compared to spent catalyst. The “regenerated catalyst” may have more coke and lesser catalytic activity compared to fresh catalyst that has not passed through a cracking reaction zone and regenerator.

As used in this disclosure, the term “fresh catalyst” refers to catalyst that has not been previously contacted with reactants at reaction conditions in a reaction zone.

The relevant figures discussed hereinbelow present non-limiting examples embodiments of reactor systems, reactors, nozzles, etc., that are suitable for use in the methods described herein. Referring now to FIG. 1, a reactor system 100 for producing olefins is schematically depicted in a batch reactor configuration. The reactor system 100 comprises a reactor vessel 102 comprising an elongated reaction tube having a substantially vertical orientation, a top end 110, and a bottom end 114. In some embodiments, the elongated reaction tube having a “substantially vertical orientation” means that a central axis of the elongated reaction tube forms an angle of at most 10 degrees with respect to the direction of gravity. The reactor system 100 further comprises a hydrocarbon feed inlet 118 proximate the bottom end 114 of the reactor vessel 102 and a catalyst injection system 200 proximate the top end 110 of the reactor vessel 102. Proximate generally refers to “nearby” in relative terms in the context of the overall architecture of the system. As used herein, the phrase “proximate the top end 110 of the reactor vessel 102” may refer to positions that are within a distance from the top end 110 of the reactor vessel 102 that is less than 20%, less than 10%, or less than 5% of the length of the reactor vessel 102 (i.e., distance between the top end 110 and the bottom end 114). As used herein, the phrase “proximate the bottom end 114 of the reactor vessel 102” may refer to positions that are within a distance from the bottom end 114 of the reactor vessel 102 that is less than 20%, less than 10%, or less than 5% of the length of the reactor vessel 102. The reactor system 100 may further comprise a catalyst container 150 configured to house a catalyst feed. The portion of the reactor vessel 102 between the hydrocarbon feed inlet 118 and the location where the catalyst injection system 200 is coupled to the reactor vessel 102 may define a reaction zone 106 of the reactor vessel 102.

With reference now to FIGS. 1, 2, 3, 4, 5, and 8, in some embodiments, the catalyst injection system 200 comprises a plurality of injector nozzles 210 each having a nozzle axis A_{N}, a nozzle tip 212 defining a nozzle end plane P_{E} that is normal to the nozzle axis A_{N}, a first inner diameter ID₁ at a first distance D₁ from the nozzle end plane P_{E} along the nozzle axis A_{N}, and a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁. Further, each injector nozzle 210 of the plurality of injector nozzles 210 has a downwards elevation angle Φ of at most 60 degrees between the nozzle axis A_{N} and the longitudinal axis A_{L} of the reactor vessel. In embodiments, carrier gas 280 may be injected into one or more of the injector nozzles 210.

The first inner diameter ID₁ may be less than or equal to 10 mm. The second inner diameter ID₂ may be greater than or equal to 2.54 mm and less than or equal to 12.7 mm. In some embodiments, the ratio of the second inner diameter ID₂ to first inner diameter ID₁ may be from about 1.5 to about 3. Without wishing to be bound by theory, it is believed that the injector nozzles 210 described herein having an inner diameter that decreases over at least some portion of the injector nozzle 210 along a catalyst flow direction FD of the injector nozzle 210 increases the velocity of the catalysts being introduced to the reactor vessel 102, which may promote reduced acceleration time and a more uniform particle distribution.

The reactor system 100 may be operable to introduce a hydrocarbon feed stream 112 into the reactor vessel 102 through the hydrocarbon feed inlet 118 proximate the bottom end 114 of the reactor vessel 102, to introduce a catalyst into the reactor vessel 102 through the catalyst injection system 200 proximate the top end 110 of the reactor vessel 102, and to contact the hydrocarbon feed stream 112 with the catalyst in the reaction zone 106 of the reactor vessel 102 to produce a cracked hydrocarbon stream and a spent catalyst, wherein the hydrocarbon feed stream 112 has a net upward superficial velocity through the reaction zone 106 and the catalyst has a net downward superficial velocity through the reaction zone 106. The reactor system 100 may be operable to contact the hydrocarbon feed stream 112 with the catalyst under reaction conditions sufficient to cause at least a portion of the hydrocarbon feed stream 112 to undergo cracking to produce light olefins such as, but not limited to, ethylene, propylene, and butylene, which may be present in a product stream 146 of the reactor system 100.

The hydrocarbon feed stream 112 and the catalyst contact each other in the reaction zone 106 in a counter-current manner. Without intending to be bound by theory, counter-current flow between the hydrocarbon feed stream 112 and the catalyst may result in an increased yield of olefins by allowing the more reactive chemicals in the hydrocarbon feed stream 112 to contact less active catalyst, and fresh catalyst to contact partially cracked reactive chemicals in the hydrocarbon feed. Generally, catalyst may become spent as it moves down through the reaction zone 106. Accordingly, more active catalyst may contact less reactive hydrocarbons near the top of the reaction zone 106, where the catalyst is introduced, and less active catalyst may contact more reactive hydrocarbons near the bottom of the reaction zone 106, where the hydrocarbon feed stream 112 is introduced. Additionally, counter-current contact of catalyst and hydrocarbons may reduce the length of the catalyst acceleration zone where catalyst is distributed within the reaction zone. Further, the combination of the counter-current contact and the use of the catalyst injection systems described herein to inject catalyst into the reactor synergistically improves gas-solid mixing between the catalyst and the hydrocarbons, thereby leading to improved conversion and selectivity in the catalytic cracking of hydrocarbons to petrochemicals.

The spent catalyst may exit the reactor vessel 102 through a catalyst outlet positioned at or proximate to the bottom end 114 of the reactor vessel 102. The cracked hydrocarbon stream may exit the top of the reaction zone 106 and flow with a net upward superficial velocity toward the top end 110 of the reactor vessel 102. In some embodiments, the cracked hydrocarbon stream produced in the reaction zone 106 may undergo further cracking as it flows between the reaction zone 106 and the top end 110 of the reactor vessel 102. Further, in one or more embodiments, a portion of the spent catalyst may also exit the top of the reaction zone 106 and flow with a net upward superficial velocity toward the top end 110 of the reactor vessel 102, moving co-currently with the cracked hydrocarbon stream.

According to one or more embodiments, the reaction zone 106 may operate with a turbulent fluidization regime. As described herein, a “turbulent fluidization regime” is similar to the transition regime from bubbling to lean phase fluidization in riser reactors. At relatively low gas velocities, particles flow downwards under gravity in dilute phase. Moreover, with the increasing gas velocity, the downward movement of particles is suspended, leading to the generation of solid clusters in a turbulent motion and voids of gas in various sizes and shapes for a dense solid status. In contrast to a bubbling regime, in a turbulent fluidization regime the tendency for bubble breakage is enhanced as the gas velocity increases. For this reason, the mean bubble size may be significantly smaller than in a bubbling fluidization regime, hence a turbulent fluidized bed may result in more uniform gas-solid contact. However, at relatively high gas velocities within a turbulent fluidization regime, pronounced radial gradients may occur with a greater concentration of solids in the wall region, while the core has a smaller concentration of solids.

In one or more embodiments, a residence time of the catalyst in the reaction zone 106 may be less than or equal to 30 seconds. For example, the residence time of the catalyst in the reaction zone 106 may be less than or equal to 30 seconds, 20 seconds, or even 15 seconds. As used herein, “residence time” refers to the average length of time a substance is in a given location. Without intending to be bound by theory, when the residence time of the catalyst in the reaction zone 106 is less than 30 seconds, fewer undesirable secondary reactions may occur that decrease the yield of desired olefin products. In one or more embodiments, a residence time of the gas in the reaction zone 106 may be less than or equal to 10 seconds.

In one or more embodiments, a temperature within the reaction zone 106 may be from 420° C. to 750° C. For example, the temperature within the reaction zone 106 may be from 420° C. to 750° C., from 420° C. to 750° C., from 460° C. to 750° C., from 500° C. to 750° C., from 540° C. to 750° C., from 580° C. to 750° C., from 620° C. to 750° C., from 660° C. to 750° C., 700° C. to 750° C., from 420° C. to 710° C., from 420° C. to 670° C., from 420° C. to 630° C., from 420° C. to 590° C., from 420° C. to 550° C., from 420° C. to 510° C., or any range or combination of ranges formed from these endpoints. In some embodiments, the temperature within the reaction zone 106 may be from 440° C. to 720° C. or from 480° C. to 680° C.

In one or more embodiments, the product stream 146 may comprise C₂ to C₄ olefins among other reaction products. For example, the product stream 146 may comprise ethylene, propylene, butylenes, or a combination thereof. In some embodiments, the product stream 146 may comprise other reaction products in addition to C₂ to C₄ olefins. For example, the product stream 146 may further comprise dry gas, aromatics, naphtha, light cycle oil, heavy cycle oil, and even heavy oil. In one or more embodiments, the hydrocarbon feed stream 112 may be diluted by steam or an inert gas such as nitrogen or argon to adjust the hydrocarbon partial pressure in the system. In such embodiments, the dilution ratio of steam or inert gas to hydrocarbons may be less than or equal to five.

The hydrocarbon feed stream 112 may include a mixture of hydrocarbon materials. The hydrocarbon materials of the hydrocarbon feed stream 112 may include a crude oil or hydrocarbons derived from crude oil. As used in this disclosure, the term “crude oil” refers to a mixture of petroleum liquids and gases, including impurities such as sulfur-containing compounds, nitrogen-containing compounds and metal compounds, as distinguished from fractions of crude oil, such as fractions obtained from separating the crude oil by boiling point temperature. In some embodiments, crude oil may include crude oil that has been minimally processed, such as to remove or reduce impurities such as heavy metals, nitrogen, sulfur, etc. The hydrocarbon feed stream 112 may include, but may not be limited to, crude oil, vacuum residue, tar sands, bitumen, atmospheric residue, vacuum gas oils, demetalized oils, naphtha streams, gas condensate streams, or combinations of these materials. The hydrocarbon feed stream 112 may include one or a plurality of non-hydrocarbon constituents, such as one or more heavy metals, sulphur compounds, nitrogen compounds, inorganic components, or other non-hydrocarbon compounds. Crude oils contemplated herein include those having an API gravity of from 25° to 50°, such as from 25° to 40°, from 25° to 30°, from 30° to 35°, from 35° to 40°, from 40° to 45°, from 45° to 50°, or any combination of these ranges. In some embodiments, the hydrocarbon feed stream 112 may comprise a fraction of crude oil, or a petrochemical product formed from a crude oil, having an initial boiling point of at least 25° C. For example, In some embodiments, the hydrocarbon feed stream 112 may comprise light naphtha and may have an initial boiling point from 25° C. to 35° C. and a final boiling point of from 85° C. to 95° C. In some embodiments, the hydrocarbon feed stream 112 may comprise heavy naphtha and may have an initial boiling point from 80° C. to 95° C. and a final boiling point from 190° C. to 210° C. In further embodiments, the hydrocarbon feed stream 112 may comprise full range naphtha and have an initial boiling point from 25° C. to 35° C. and a final boiling point from 190° C. to 210° C.

In one or more embodiments, the hydrocarbon feed stream 112 may comprise one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphalted-dewaxed crude oil, kerosene, diesel, or methanol. In one or more embodiments, the hydrocarbon feed stream 112 may comprise one or more hydrocarbon streams comprising paraffins, olefins, or both.

In some embodiments, the catalyst may comprise a zeolite catalyst, such as but not limited to a USY zeolite, a ZSM-5 zeolite, or a combination of multiple types of suitable zeolite catalysts. Alternatively or additionally, the catalyst may comprise other suitable solid acid catalysts. In some embodiments, the catalyst may comprise fresh catalyst, regenerated catalyst, or combinations of fresh and regenerated catalyst as described in further detail herein. In some embodiments, the catalyst may comprise binders, cracking promoters, inert fillers, matrix materials, or combinations of these to have acceptable physical and chemical properties to the catalyst, such as but not limited to catalyst attrition index and catalyst density, so that the catalyst can be used in the proposed reactor configuration.

Referring again to FIG. 1, the catalyst injection systems 200 described herein may further comprise a catalyst distribution system 220 that receives catalyst, e.g., from a catalyst container 150 such as a catalyst hopper, and distributes the catalyst to a plurality of nozzle feed lines 222 coupled to respective injector nozzles 210 of the catalyst injection system 200. In embodiments, the catalyst distribution system 220 may comprise two or more feed lines 222 to be connected with injector nozzles 210 equidistantly or non-equidistantly distributed around the circumference of the reactor vessel 102.

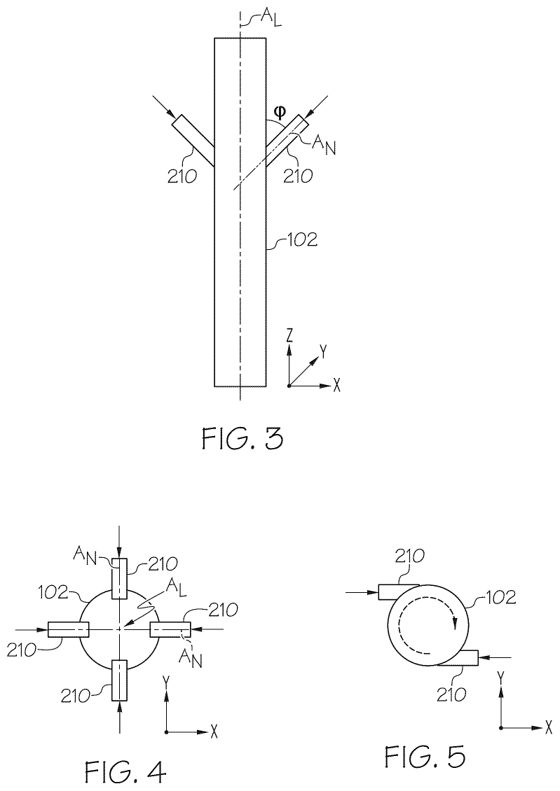

With reference now to FIG. 3, each injector nozzle 210 of the plurality of injector nozzles 210 may have a downwards elevation angle Φ of at most 60 degrees between the nozzle axis A_{N} and the longitudinal axis A_{L} of the reactor vessel. Without wishing to be bound by theory, it is believed that maintaining the downwards elevation angle Φ of the injector nozzles 210 to at most 60 degrees may improve the contact dynamics between the hydrocarbon feed stream 112 and the catalyst particles. Moreover, as an initial net downward velocity can be created for the catalyst particles, the catalyst injection system shortens the acceleration time.

In one or more embodiments, the downwards elevation angle Φ of each injector nozzle is at most 55 degrees, at most 50 degrees, at most 45 degrees, at most 40 degrees, at most 35 degrees, at most 30 degrees, at most 25 degrees, at most 20 degrees, at most 15 degrees, at most 10 degrees, or at most 5 degrees. In one or more embodiments, each injector nozzle 210 may extend into the reactor vessel 102 a length that is less than or equal to 40% of the diameter of the reactor vessel 102 at the location where the catalyst injection system 200 is coupled to the reactor vessel 102 (i.e., where the injector nozzles 210 enter the reactor vessel 102). In some embodiments, each injector nozzle 210 may extend into the reactor vessel 102 a length that is less than or equal to 30%, less than or equal to 20%, less than or equal 10%, less than or equal to 5%, less than or equal to 4%, less than or equal to 3%, less than or equal to 2%, or less than or equal to 1% of the diameter of the reactor vessel 102 at the location where the catalyst injection system 200 is coupled to the reactor vessel 102. In particular embodiments, the distal end of the nozzle tip 212 of each injector nozzle 210 may be flush with an interior surface of the reactor vessel 102.

With reference now to FIG. 4, in some embodiments, each of the injector nozzles 210 may be perpendicularly oriented such that the nozzle axis A_{N} of each injector nozzle 210 intersects the longitudinal axis A_{L} of the reactor vessel 102. The plurality of injector nozzles 210 may include at least two injector nozzles, at least three injector nozzles, at least four injector nozzles, at least five injector nozzles, at least six injector nozzles, at least seven injector nozzles, or at least eight injector nozzles. The injector nozzles 210 of the plurality of injector nozzles 210 may be equally or unequally spaced about the circumference of the reactor vessel 102. In some embodiments, the plurality of injector nozzles 210 may include at least two rows of injector nozzles 210 positioned at different heights of the reactor vessel 102.

Referring now to FIG. 5, in some embodiments, each injector nozzle 210 may be tangentially oriented with respect to the wall of the reactor vessel 102. In the embodiment shown in FIG. 5, the plurality of injector nozzles 210 includes two tangentially oriented injector nozzles 210 positioned on opposite sides of the reactor vessel 102. Without wishing to be bound by theory, it is believed that tangentially oriented injector nozzles 210 may facilitate a vortex flow pattern of the catalyst being introduced through the catalyst injection system 200, and that this vortex flow pattern may improve gas-solid contact.

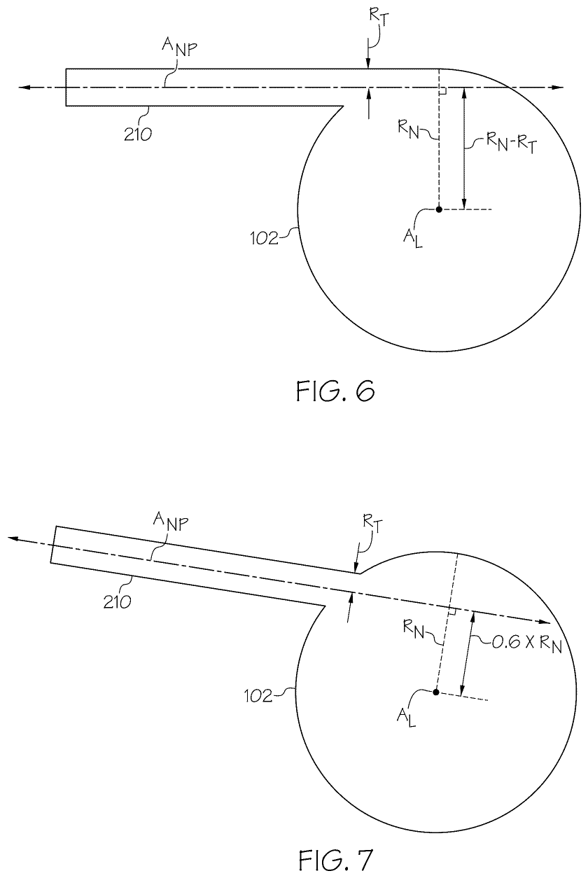

With reference now to FIGS. 6 and 7, in one or more embodiments, each injector nozzle 210 may be positioned such that its nozzle projected axis A_{NP}, i.e., a projection of the nozzle axis A_{N} of the injector nozzle 210 on a plane P normal to the longitudinal axis A_{L} of the reactor vessel 102 where the nozzle injector 210 is coupled to the reactor vessel 102, intersects a radius normal R_{N} of the reactor vessel 102 at a distance from the longitudinal axis A_{L} that is greater than zero and less than or equal to R_{N}−R_{T}, wherein R_{T} is the radius of the injector nozzle. As used herein, the “radius normal R_{N}” with respect to the orientation of an injector nozzle 210 refers to a radius of the reactor vessel 102 that is perpendicular to the nozzle projected axis A_{NP}, as shown in FIGS. 6 and 7. In the embodiment shown in FIG. 6, the depicted injector nozzle 210 is tangentially oriented such that its nozzle projected axis A_{NP} intersects its radius normal R_{N} of the reactor vessel 102 at a distance from the longitudinal axis A_{L} that is equal to R_{N}−R_{T}. In the embodiment shown in FIG. 7, the depicted injector nozzle 210 has an angled orientation between a perpendicular orientation (see FIG. 4) and a tangential orientation (see FIGS. 5 and 6). In some embodiments, each injector nozzle 210 may be positioned such that its nozzle projected axis A_{NP} intersects its radius normal R_{N} of the reactor vessel at a distance from the longitudinal axis A_{L} that is greater than or equal to 0.1×R_{N}, greater than or equal to 0.2×R_{N}, greater than or equal to 0.3×R_{N}, greater than or equal to 0.4×R_{N}, greater than or equal to 0.5×R_{N}, greater than or equal to 0.6×R_{N}, greater than or equal to 0.7×R_{N}, greater than or equal to 0.8×R_{N}, or greater than or equal to 0.9×R_{N}.

Referring again to FIG. 8, in one or more embodiments, each injector nozzle 210 comprises a first nozzle segment 230 having the first inner diameter ID₁ and comprising a first proximal end 230a and a first distal end 230b, and a second nozzle segment 232 having the second inner diameter ID₂ and comprising a second proximal end 232a and a second distal end 232b. As used herein, the terms “proximal” and “distal,” in the context of the structure of the injector nozzles 210, indicate the relative position of components with respect to the nozzle end plane P_{E} of the injector nozzle 210, with “distal” indicating a position relatively closer to the nozzle end plane P_{E} and “proximal” indicating a position relatively further from the nozzle end plane P_{E}. Each injector nozzle 210 may further comprise a first tapered connector 240 interposed between the first nozzle segment 230 and the second nozzle segment 232 and fluidly connecting the first proximal end 230a of the first nozzle segment 230 to the second distal end 232b of the second nozzle segment 232.

In some embodiments, each injector nozzle further comprises a third nozzle segment 234 having a third inner diameter ID₃ and comprising a third proximal end 234a and a third distal end 234b, and a second tapered connector 242 interposed between the second nozzle segment 232 and the third nozzle segment 234 and fluidly connecting the second proximal end 232a of the second nozzle segment 232 to the third distal end 234b of the third nozzle segment 234, wherein the third inner diameter ID₃ is greater than the second inner diameter ID₂. The third inner diameter ID₃ may be greater than or equal to 6.35 mm and less than or equal to 25.4 mm. In some embodiments, the ratio of the third inner diameter ID₃ to second inner diameter ID₂ may be from about 1.5 to 3.

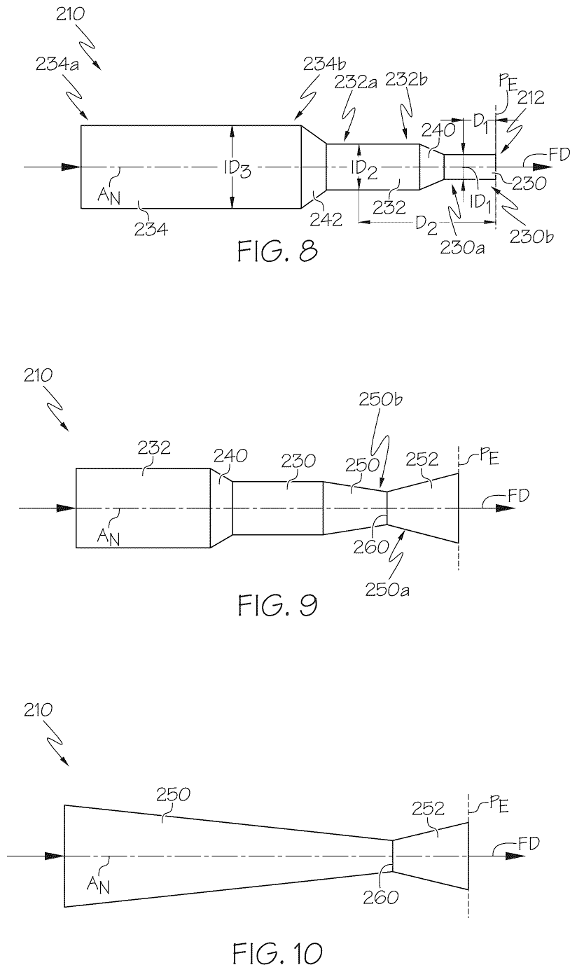

Referring now to FIG. 9, in one or more embodiments, each injector nozzle 210 comprises the first nozzle segment 230, the second nozzle segment 232, and the first tapered connector 240 described above, and further comprises a first tapered nozzle segment 250 that is tapered in a nozzle flow direction FD of the injector nozzle 210 and fluidly connected to the first distal end 230b of the first nozzle segment 230, and a second tapered nozzle segment 252 that is tapered in a direction opposite the nozzle flow direction FD and fluidly connected to a distal end 250b of the first tapered nozzle segment 250, and wherein a connection point between the distal end 250b of the first tapered nozzle segment 250 and a proximal end 252a of the second tapered nozzle segment 252 defines a throat 260 of the injector nozzle 210. In the nozzle configuration shown in FIG. 9 the inner diameter of the injector nozzle 210 decreases from the second nozzle segment 232 to the first nozzle segment 230, before being reduced further by the first tapered nozzle segment 250 to the throat 260, and then finally increasing again via an expansion section defined by the second tapered nozzle segment 252. Without wishing to be bound by theory, it is believe that the decreasing diameters in series towards the tip of the nozzle accelerates the catalyst with initial velocities, while after passing the throat section, the expansion section offers better and wider dispersion area of the catalysts into the reactor vessel 102 for better gas-solid contact. In other embodiments, each injector nozzle 210 may comprise the first tapered nozzle segment 250 and the second tapered nozzle segment 252 without the first nozzle segment 230, the second nozzle segment 232, and the first tapered connector 240, as shown in FIG. 10. In such embodiments, the first tapered nozzle segment 250 may have an extended length relative to the second tapered nozzle segment 252, such as, for example, at least 1.5 times, at least 2 times, at least 3 times, at least 5 times, or at least 10 times the length of the second tapered nozzle segment 252 in the direction of the nozzle axis A_{N}. This configuration simplifies the injection nozzle system with a gradually decreasing diameter for catalyst acceleration, and the expansion section leads to wider dispersion area of the catalysts into the reactor vessel 102 for better gas-solid contact.

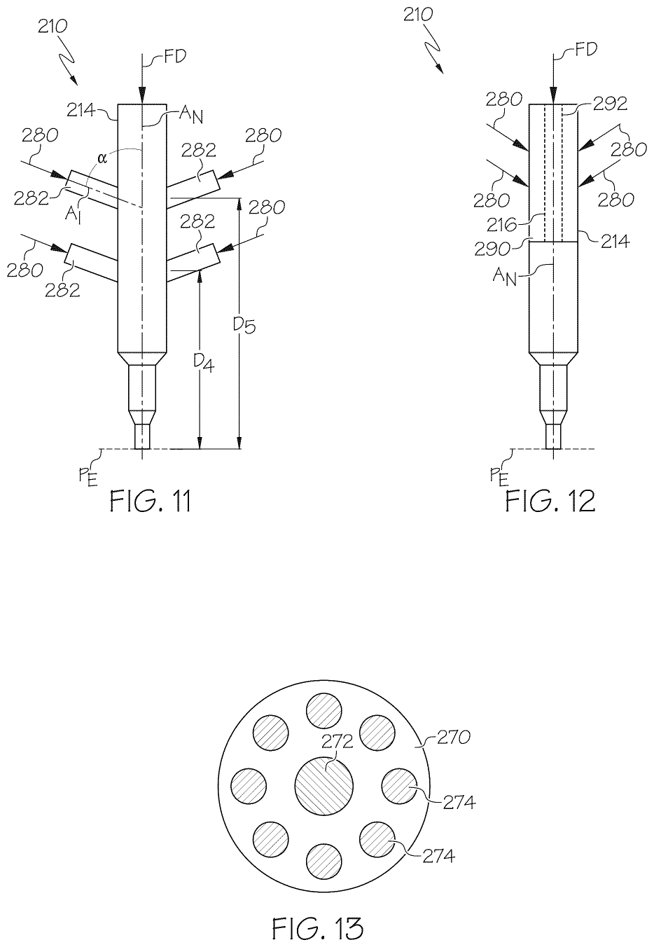

Referring now to FIGS. 11 and 12, the methods described herein may further comprise injecting carrier gas 280 into each injector nozzle 210 to facilitate the introduction of the catalyst into the reactor vessel 102 through the injector nozzles 210 of the catalyst injection system 200. For example, in the embodiment shown in FIG. 11, carrier gas 280 is injected into each injector nozzle 210 through a plurality of carrier gas injectors 282 coupled to a circumferential wall 214 of the injector nozzle 210 and having an injector axis A_{I} that forms an angle α with the nozzle axis A_{N}. The plurality of carrier gas injectors 282 may comprise a first set of carrier gas injectors 282 coupled to the circumferential wall 214 of the injector nozzle at a fourth distance D₄ from the nozzle end plane P_{E} along the nozzle axis A_{N}, and a second set of carrier gas injectors 282 coupled to the circumferential wall 214 of the injector nozzle 210 at a fifth distance D₅ from the nozzle end plane P_{E} along the nozzle axis A_{N}, wherein the fifth distance is greater than the fourth distance, as shown in FIG. 11. In embodiments, the carrier gas 280 may be steam or any inert gas for the catalytic cracking reaction, for example, nitrogen gas or argon gas.

In some embodiments, each injector nozzle 210 further comprises a carrier gas distribution chamber 290 radially surrounding a central passageway 216 of the injector nozzle 210 and separated from the central passageway 216 by a perforated inner wall 292, as shown in FIG. 12. In such embodiments, carrier gas 280 is first injected into the carrier gas distribution chamber 290 before passing through holes in the perforated inner wall 292 to fluidize the catalyst and assist in the transport of the catalyst through the injector nozzle 210.

The nozzle tip 212 of each of the injector nozzles 210 may be open-ended such that, for example, the injector nozzle 210 comprises an axial hole at the nozzle tip 212 having a diameter equal to the first inner diameter ID₁. However, the injector nozzles 210 may alternatively include a catalyst distributor plate 270 comprising a plurality of holes for the catalyst to pass through, as shown in FIG. 13. In the embodiment shown in FIG. 13, the plurality of holes comprises a central hole 272 having a central hole diameter HD_{C} and a plurality of radial holes 274 equidistant from the central hole 272 and having a radial hole diameter HD_{R} that is less than the central hole diameter HD_{C}. In some embodiments, the plurality of radial holes 274 may be arranged to be axisymmetric about the nozzle axis A_{N}, as shown in FIG. 13.

In embodiments, the injector nozzles 210 may inject catalyst into the reactor vessel 102 at a particle injection velocity in the flow direction FD of the injector nozzle 210 of at least 0.5 m/s, at least 0.6 m/s, at least 0.7 m/s, at least 0.8 m/s, at least 0.9 m/s, at least 1.0 m/s, at least 1.1 m/s, at least 1.2 m/s, at least 1.3 m/s, at least 1.4 m/s, at least 1.5 m/s, at least 1.6 m/s, at least 1.7 m/s, at least 1.8 m/s, at least 1.9 m/s, or at least 2.0 m/s.

It should be understood that while the present disclosure describes particular features of the injector nozzles by referring to “each” injector nozzle 210 of the plurality of injector nozzles 210, embodiments are also contemplated wherein different types of injector nozzles 210 are utilized for a single catalyst distribution system 200. For example, embodiments are contemplated wherein injector nozzles 210 have different downwards elevation angles @, different angular orientations with respect to the nozzle projected axis A_{NP} and the longitudinal axis A_{L} of the reactor vessel 102, different nozzle configurations (e.g., among those shown in FIGS. 8-10), and different types carrier gas injection designs (e.g., among those shown in FIGS. 11 and 12). That is, the nozzle types for the injector nozzles 210 are not required to be the same. However, without wishing to be bound by theory, it is believed that utilizing the same nozzle types for the plurality of injector nozzles 210, and arranging the injector nozzles symmetrically around the reactor vessel 102, may be beneficial for achieving a uniform distribution of the catalyst particles being injected into the reactor vessel 102.

In one or more embodiments, catalyst in the catalyst container 150 may be fluidized before being passed to the catalyst injection system 200, for example, by passing a fluidization gas 152 (e.g., nitrogen gas, argon gas, or steam) into the catalyst container 150. The fluidization gas 152 may exit the top of the catalyst container 150 as an exit fluidization gas stream 154. The catalyst container 150 may have a hopper structure containing an upper cylindrical portion and a lower conical portion (e.g., making up at most 50% of the total height of the catalyst container 150). The catalyst feed in the catalyst container 150 may be fresh catalyst, regenerated catalyst, or a combination of fresh and regenerated catalyst.

In one or more embodiments, the reactor system 100 further comprises a freeboard zone 131 disposed axially above the reactor vessel 102 and in fluid communication with the top end 110 of the reactor vessel 102. The freeboard zone 131 may have an inlet diameter at an inlet 133 of the freeboard zone 131 and an outlet diameter at the outlet 135 of the freeboard zone 131 that is larger than the inlet diameter. The freeboard zone 131 increase in cross-sectional area reduces the superficial velocity of any entrained catalyst within the cracked hydrocarbon fluids to fall back to the top end 110 of the reaction zone 106, thereby allowing for the disengagement of product vapor from the catalyst particles. As vapor and catalyst particles suspended therein enter the freeboard zone 131, the vapor continues to rise due to its upward superficial velocity, while any of the catalyst that is entrained in the vapor phase may fall due the greater density of the catalyst and also due to the decrease in the upward superficial velocity of the vapors in the freeboard zone 131 (resulting from the increase in cross-sectional area). The freeboard zone 131 may decrease the superficial velocity of the vapor phase to a superficial velocity at which the vapors are no longer able to entrain the heavier of the catalyst particles, allowing the catalyst particles to fall back to the top end 110 of the reactor vessel 102. In this way, the freeboard zone 131 assists in separating the vapor from the catalyst.

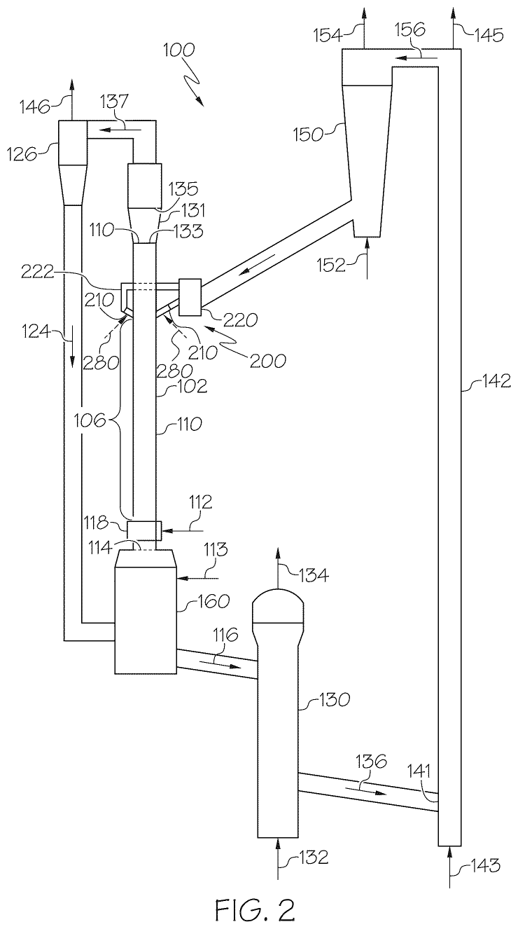

Referring again to FIG. 2, in one or more embodiments, the reactor system 100 may further comprise an internal recycle loop adopted to utilize the different particle fractions to promote heat transport and heterogeneous chemical reactions and to recycle the fine catalyst particles from the cracked hydrocarbons that cannot move downward by gravity in the reactor. In such embodiments, the reactor system 100 may further comprise a separator 126 configured to receive an intermediate product stream 137 emerging from reactor vessel 102 or the freeboard zone 131 (if present). The separator 126 may be any suitable gas/solid separation device. In one or more embodiments, the separator 126 may comprise a cyclone separator. The separator 126 may be designed to efficiently separate remaining fine catalyst particles from the cracked hydrocarbons in the intermediate product stream to produce a fine spent catalyst 124 and the product stream 146. The separator 126 as a cyclone separator may operate under a combination of centrifugal force, gravity settling, and the specific design of the cyclone chamber. In some embodiments, the fine spent catalyst 124 may be combined with the spent catalyst, e.g., downstream the dense bed reaction zone of the dense bed reactor 160, to form a combined spent catalyst that may be passed to the stripping unit 130. This embodiment offers the flexibility of further cracking with the upward flow of fine catalyst particles above the reaction zone 106.

In one or more embodiments, the reactor system 100 further comprises a stripping unit 130 in fluid communication with the bottom end of the reactor vessel 102. In the stripping unit 130, at least a portion of hydrocarbons entrained within the spent catalyst may be removed to form a stripped catalyst 136. The location of the stripping unit 130 relative to the reactor vessel 102 is not necessarily limited. For example, as depicted in FIG. 1, the stripping unit 130 may be integrated with the reactor vessel 102. In some embodiments, as depicted in FIG. 2, the stripping unit 130 may be a standalone unit, positioned apart from the reactor vessel 102.

Without intending to be bound by theory, the catalyst may be porous and hydrocarbons from the hydrocarbon feed stream 112 may be entrained within the pores of the spent catalyst. Removing at least a portion of the hydrocarbons entrained within the pores of the spent catalyst may reduce secondary thermal and catalytic cracking reactions. In some embodiments of the systems described herein comprising a regenerator 140 (discussed below), this may reduce the coke load to the regenerator 140. The hydrocarbons entrained within the spent catalyst may be removed in the stripping unit 130 by any suitable means. For example, a stripping fluid 132 may be passed to the stripper to contact the spent first portion of the catalyst and the spent second portion of the catalyst to form a stripped catalyst 136. In one or more embodiments, the stripping fluid 132 may enter the stripping unit 130 at or near the bottom of the stripping unit 130. In some embodiments, the stripping fluid 132 may comprise steam, an inert gas, or both. In one or more embodiments, the stripping fluid 132, after contacting the spent catalyst, may be passed from the stripping unit 130 in stream 134, which may be passed directly to the condenser 147 to maintain the pressure profile in the system.

In one or more embodiments, the reactor system 100 has a continuous reactor configuration as schematically depicted in FIG. 2, and further comprises a regenerator 140 configured to regenerate at least a portion of the stripped catalyst 136 to form a regenerated catalyst 156. The regenerator 140 may perform any process that improves the catalytic activity of the stripped catalyst 136. For example, in one or more embodiments, regenerating the stripped catalyst 136 may comprise burning coke.

The catalyst regenerator 140 may comprise a riser 142 having a stripped catalyst inlet 141 configured to receive the stripped catalyst 136 from the stripping unit 130. The stripped catalyst inlet 141 may be positioned at or near the bottom of the riser 142. The regenerator 140 may be operable to contact the stripped catalyst 136 with an oxygen-containing gas 143 (e.g., air) that is passed to the riser 142, which may cause combustion of coke deposits on the stripped catalyst 136. The oxygen-containing gas 143 and the stripped catalyst 136 may travel up the riser 142 in a co-current manner regenerating the stripped catalyst 136 to form the regenerated catalyst 156 and regenerator flue gas 145. In some embodiments, the CO₂ in the regenerator flue gas 145 is monitored for a mass balance calculation.

In one or more embodiments, the regenerated catalyst 156 and regenerator flue gas 145 may be passed from the riser 142 to a separator (not shown). In one or more embodiments, the riser 142 and the separator are adjacent such that the regenerated catalyst 156 and the regenerator flue gas 145 are passed directly from the riser 142 to the separator. The separator may be any suitable separation system for separating the regenerated catalyst 156 from the regenerator flue gas 145, including a cyclone separation system. The separator may be fluidly coupled to the catalyst injection system 200 of the reactor vessel 102 to transfer regenerated catalyst 156 from the regenerator 140 back to the reaction zone 106 of the reactor vessel 102. In some embodiments, fresh catalyst may be added to regenerated catalyst 156 in the catalyst container 150. In such embodiments, the catalyst introduced to the reactor vessel 102 may comprise both regenerated catalyst and fresh catalyst.

In one or more embodiments, the regenerated catalyst 156 may be passed to the catalyst container 150. As previously discussed, the catalyst container 150 may comprise a fluidized bed of regenerated catalyst 156. In one or more embodiments, a fluidization gas 152 may be passed to the catalyst container 150 to fluidize the regenerated catalyst 156 within the catalyst container 150. The catalyst container 150 may have any suitable shape. For example, the catalyst container 150 may be integrated with the regenerator 140. In such embodiments, the riser 142 may pass through at least a portion of the catalyst container 150. In some embodiments, for example, the embodiment depicted in FIG. 2, the catalyst container 150 may be a stand-alone unit. In one or more embodiments, the regenerated catalyst 156 may be passed to the catalyst injection system 200 from the catalyst container 150.

Referring again to FIG. 2, the reactor system 100 may further comprise a dense bed reactor 160 positioned axially below the reactor vessel 102 such that the spent catalyst may be passed directly from the reactor vessel 102 to the dense bed reactor 160. In some embodiments including a dense bed reactor 160, the hydrocarbon feed inlet 118 may be coupled to the dense bed reactor 160 so as to introduce the hydrocarbon feed stream 112 into the dense bed reactor at a height of between 10% and 80% of the height of the dense bed reactor 160. This configuration is believed to promote initial feed cracking under ultra-fast gas-solid contact conditions. However, in other embodiments, the dense bed reactor 160 may be configured to contact the spent catalyst produced in the reaction zone 106 with a second hydrocarbon feed stream 113, as schematically depicted in FIG. 2. In one or more embodiments, hydrocarbons may be passed from the dense bed reactor 160 up to the reactor vessel 102 and the spent catalyst, which may have acquired additional hydrocarbons via contact with the second hydrocarbon feed stream 113, may be passed to the stripping unit 130 as further spent catalyst 116.

In one or more embodiments, the second hydrocarbon feed stream 113 has a net upward superficial velocity through a dense bed reaction zone of the dense bed reactor 160 and the spent catalyst has a net downward superficial velocity through the dense bed reaction zone. The dense bed reaction zone may operate with a dense bed fluidization regime. As described herein, a “dense bed fluidization regime” refers to a fluidization regime in which the fluidized bed has a clearly defined upper limit or surface to the dense bed. For example, dense bed fluidization regimes include the smooth fluidization, bubbling fluidization, slugging fluidization, and turbulent fluidization regimes. In a dense fluidized bed, the particle entrainment rate may be low, but may increase as the velocity of the gas flowing through the bed increases. Without intending to be bound by theory, the dense bed reaction zone may improve the flexibility of the reactor by providing a reaction zone with fast contact between a hydrocarbon feed stream and the catalyst as an initial cracking stage.

### EXAMPLES

The following examples illustrate one or more features of the present disclosure. The examples are illustrative in nature, and should not be understood to limit the subject matter of the present disclosure.

### Example 1: Simulated Counter-Current Downer

In order to demonstrate the concepts described herein, the hydrodynamics of counter-current downers were simulated using computational particle fluid dynamics (CPFD) software Barracuda Virtual Reactor (Houston, Texas) where the influence of particle injection velocity and injector orientation on solid holdup, particle velocity, and particle residence time were analyzed. The modeled reactor had a diameter of 25.4 mm and a height of 4 meters. A typical FCC catalyst was utilized for the simulations (1500 kg m⁻³; average particle size: 75 μm) to process 1.5 kg h⁻¹ of Arabian Light crude oil (10 wt % steam) at the reaction condition of 650° C. and 2.5 bar. A uniform catalyst injection was created by 13 injectors positioned as described in Table 1, with the same injection velocity along the gravity direction at the height of 2.5 meters. Different initial velocities were applied (0.5 m s⁻¹, 1.0 m s⁻¹, 1.5 m s⁻¹, 1.8 m s⁻¹, 2.0 m s⁻¹) to feed the catalyst particles into the reactor using a catalyst/oil ratio of 30, while injection failure appeared at the velocity of 0.5 m s⁻¹.

TABLE 1
Injector positions for the counter-current downer simulations

| Injector | 01 | 02 | 03 | 04 | 05 | 06 | 07 | 08 | 09 | 10 | 11 | 12 | 13 |
|---|---|---|---|---|---|---|---|---|---|---|---|---|---|
| X (mm) | 4 | 8 | 12 | −4 | −8 | −12 | 0 | 0 | 0 | 0 | 0 | 0 | 0 |
| Y (mm) | 0 | 0 | 0 | 0 | 0 | 0 | 0 | 4 | 8 | 12 | −4 | −8 | −12 |
| Z (m) | 2.5 | 2.5 | 2.5 | 2.5 | 2.5 | 2.5 | 2.5 | 2.5 | 2.5 | 2.5 | 2.5 | 2.5 | 2.5 |

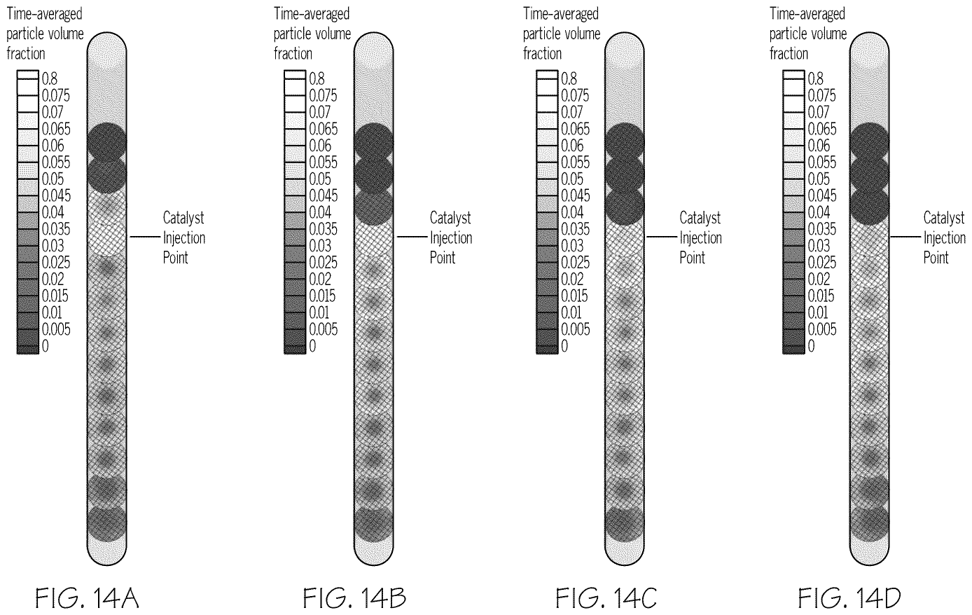

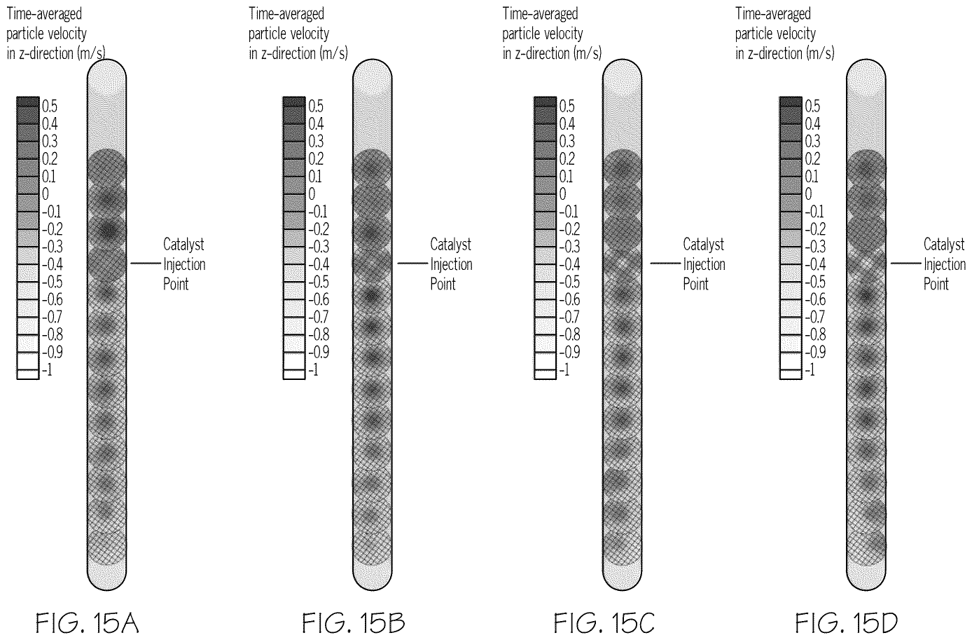

FIGS. 14A-14D depict the time-averaged radial solid holdup of 13 equidistant planes under injection velocities of 1.0 m s⁻¹, 1.5 m s⁻¹, 1.8 m s⁻¹, 2.0 m s⁻¹, respectively. FIGS. 15A-15D depict the time-averaged particle velocity in the vertical direction of the same 13 equidistant planes under injection velocities of 1.0 m s⁻¹, 1.5 m s⁻¹, 1.8 m s⁻¹, 2.0 m s⁻¹, respectively. Solid holdup and particle velocity display similar distribution along the reactor under different injection velocities. Fluctuation appears around the injection point with a local dense distribution area under solid holdup higher than 5%, which decreases along the gravity with a stable uniform core-shell effect in the main counter-current operation area of the reactor. Particles accelerate after injection, with enhanced core-shell distribution, by increasing the injection velocity.

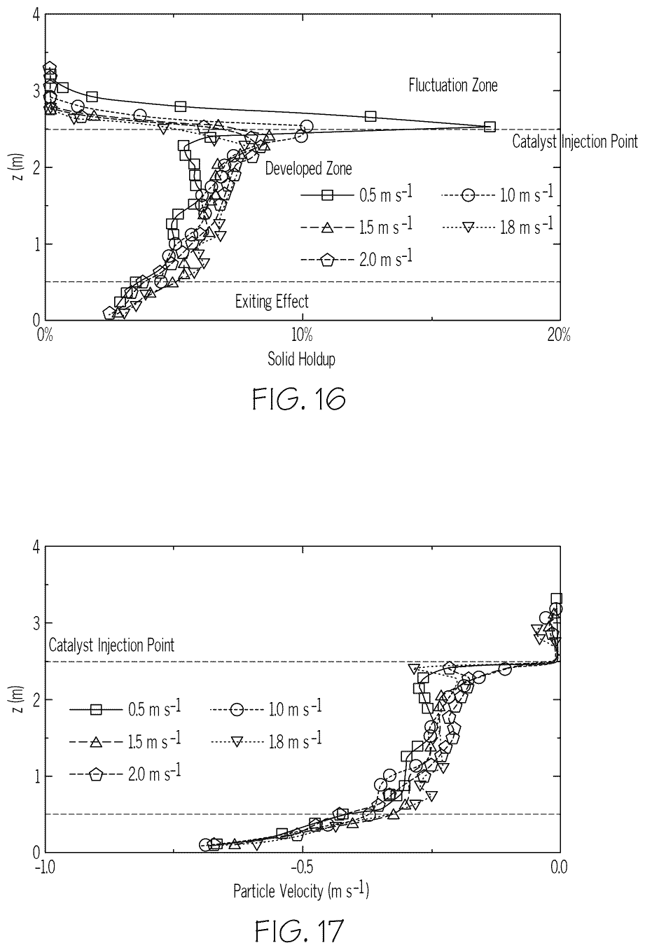

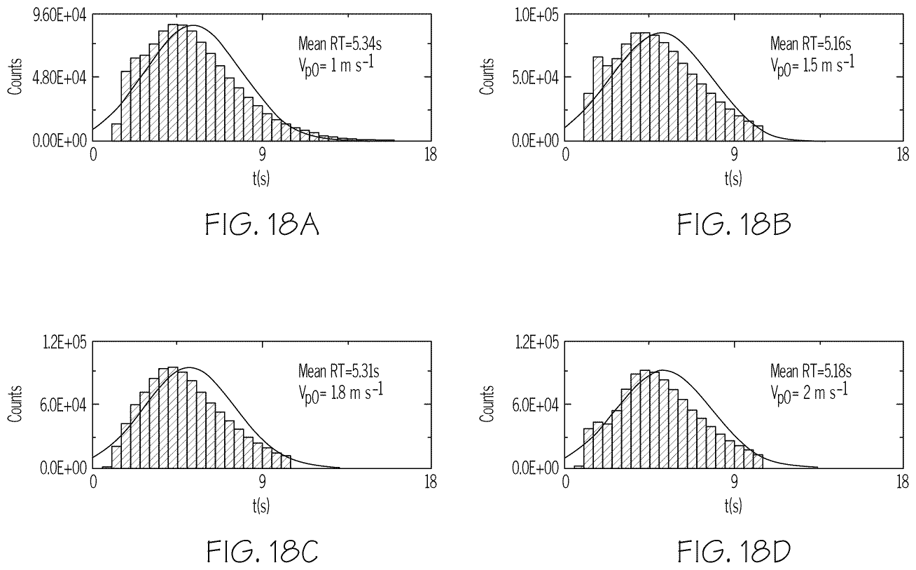

FIG. 16 graphically depicts simulated time- and area-averaged solid holdup of 26 isometric planes (from Z=0 to 3.3 m) along the reactor under injection velocities of 0.5 m s⁻¹, 1.0 m s⁻¹, 1.5 m s⁻¹, 1.8 m s⁻¹, and 2.0 m s⁻¹. FIG. 17 graphically depicts simulated time- and area-averaged particle velocity of 26 isometric planes (from Z=0 to 3.3 m) along the reactor under injection velocities of 0.5 m s⁻¹, 1.0 m s⁻¹, 1.5 m s⁻¹, 1.8 m s⁻¹, and 2.0 m s⁻¹. Three hydrodynamic zones can be recognized: a fluctuation zone, a developed zone, and an exiting zone. Catalyst injection failure appeared for the velocity of 0.5 m s⁻¹, while the average solid holdup and particle velocity are similar under injection velocities of 1 m s⁻¹ and above. Simulation results show that a certain injection velocity is needed to feed the required catalyst flow into the reactor, and a high-density operation of the counter-current downer (solid holdup >5%) can be achieved by increasing the injection velocity. In other words, catalyst injector designs providing a relatively high injection velocity along the gravity direction benefit the high-density operation of the counter-current downer reactor for optimized gas-solid interaction and enhanced process efficiency.

The particle residence time distribution (RTD) under different injection velocities Vₚ₀ was also analyzed, the results of which are illustrated in the histogram analysis shown in FIGS. 18A-18B. The particle RTDs approach Gaussian distribution with similar CSTR behaviors under all conditions, indicating that the particle RTD is almost independent of the injection velocity. The gas residence time distribution at different heights was also analyzed, the results of which are shown in Table 2 below along with the particle residence time distributions.

TABLE 2
Particle and gas residence time under different injection velocities of a
counter-current downer (1 inch) for FCC particles (1500 kg m⁻³, average size: 75 μm) to
handle Arabian Light crude oil of 1.5 kg h⁻¹ with steam fraction of 10% at 650° C. and 2.5 bar

| Vₚ₀ | RTD | RTD gas (s) | | | | | |
|---|---|---|---|---|---|---|---|
| (m s⁻¹) | solid (s) | Z1 = 1.25 m | Z2 = 1.75 m | Z3 = 2 m | Z4 = 2.25 m | Z5 = 2.75 m | Z6 = 3 m |
| 0.5 | 6.01 | 0.80 | 1.12 | 1.33 | 1.56 | 2.06 | 2.29 |
| 1 | 5.34 | 1.03 | 1.56 | 1.72 | 1.95 | 2.44 | 2.70 |
| 1.5 | 5.16 | 1.30 | 1.93 | 2.17 | 2.36 | 2.78 | 3.02 |
| 1.8 | 5.31 | 0.72 | 1.06 | 1.32 | 1.50 | 2.10 | 2.37 |
| 2 | 5.18 | 0.48 | 0.72 | 0.84 | 1.06 | 1.73 | 1.99 |

As a result of back-mixing and turbulence caused by the injection, the gas RTD at each height first increases with the injection velocity, then decreases. This demonstrates that a controlled gas residence time can be achieved by adjusting the catalyst injector and injection velocity, offering flexibility to regulate the system.

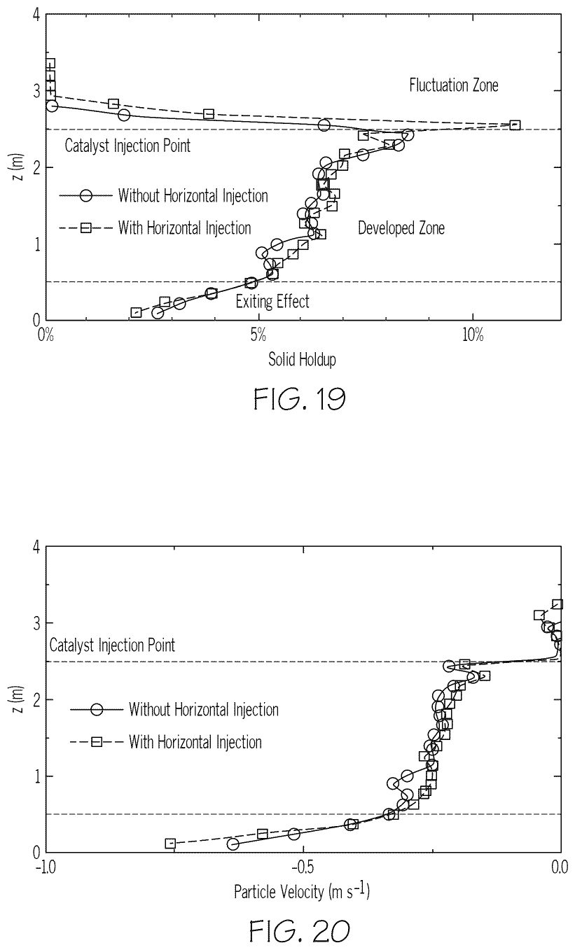

In order to investigate the effect of the catalyst injection orientation for the counter-current downer, addition simulations were performed using the same reactor configuration and input streams using a particle injection velocity of 1.5 m s⁻¹, but where injectors 01, 04, 08, and 11 were provided with a downwards elevation angle Φ with respect to the longitudinal axis of the reactor vessel of 45 degrees. FIG. 19 graphically depicts simulated time-(from 10 to 20 seconds) and area-averaged solid holdup of 26 isometric planes (from Z=0 to 3.3 m) along the reactor with and without horizontal injection velocities (i.e., a downwards elevation angle Φ of 45 degrees). Similar zones of fluctuation, developed, and exiting can be observed. The solid holdup and particle velocity results display similar trends with slightly increased uniformity when a horizontal injection velocity is applied. The results demonstrate that the catalyst injection systems of the present disclosure, implementing injector nozzles having a downwards elevation angle Φ of at most 60 degrees, may achieve improved particle uniformity.

Overall, the present disclosure provides catalyst injector designs for the fluidized catalytic cracking system using a counter-current downer as the main reactor to create initial particle velocities along the horizontal and vertical direction with the potential for vortex effects. With the advantages of shortening the acceleration, improving the gas-solid contact by high-density operations, and adjusting gas residence time, the catalyst injection systems described herein may further enhance the reactant contact with the active site for improved conversion and selectivity, offer flexibility to adjust the system operation, and provide process intensification chances with less capital investment.

According to a first aspect of the present disclosure, a method for processing hydrocarbons comprises introducing a hydrocarbon feed stream into a reactor vessel through a hydrocarbon feed inlet proximate a bottom end of the reactor vessel, introducing a catalyst into the reactor vessel through a catalyst injection system proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone, wherein the catalyst injection system comprises a plurality of injector nozzles, and wherein one or more injector nozzles of the plurality of injector nozzles comprises: a nozzle axis A_{N}; a nozzle tip defining a nozzle end plane P_{E} that is normal to the nozzle axis A_{N}; a first inner diameter ID₁ at a first distance D₁ from the nozzle end plane P_{E} along the nozzle axis A_{N}; a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁; and a downwards elevation angle Φ of at most 60 degrees between the nozzle axis A_{N} and a longitudinal axis A_{L} of the reactor vessel.

A second aspect includes the first aspect, wherein the nozzle axis A_{N} of each injector nozzle intersects the longitudinal axis A_{L} of the reactor vessel.

A third aspect includes either one of the first or second aspects, wherein the plurality of injector nozzles comprises at least four injector nozzles equally spaced about a circumference of the reactor vessel.

A fourth aspect includes the first aspect, wherein each injector nozzle comprises: a nozzle tip radius R_{T}; and a nozzle projected axis A_{NP}, wherein the nozzle projected axis A_{NP} is a projection of the nozzle axis A_{N} on a plane P normal to a longitudinal axis A_{L} of the reactor vessel, and wherein each injector nozzle is positioned such that its nozzle projected axis A_{NP} intersects a radius normal R_{N} of the reactor vessel at a distance from the longitudinal axis A_{L} that is greater than or equal to 0.1×R_{N} and less than or equal to R_{N}−R_{T}.

A fifth aspect includes any one of the first, second, or fourth aspects, wherein the plurality of injector nozzles comprises two injector nozzles positioned on opposite sides of a cross-section of the reactor vessel.

A sixth aspect includes any one of the first through fifth aspects, wherein each injector nozzle comprises: a first nozzle segment having the first inner diameter ID₁ and comprising a first proximal end and a first distal end; a second nozzle segment having the second inner diameter ID₂ and comprising a second proximal end and a second distal end; and a first tapered connector interposed between the first nozzle segment and the second nozzle segment and fluidly connecting the first proximal end of the first nozzle segment to the second distal end of the second nozzle segment.

A seventh aspect includes the sixth aspect, wherein each injector nozzle further comprises: a third nozzle segment having a third inner diameter ID₃ and comprising a third proximal end and a third distal end; and a second tapered connector interposed between the second nozzle segment and the third nozzle segment and fluidly connecting the second proximal end of the second nozzle segment to the third distal end of the third nozzle segment, wherein the third inner diameter ID₃ is greater than the second inner diameter ID₂.

An eighth aspect includes either one of the sixth or seventh aspects, wherein each injector nozzle further comprises: a first tapered nozzle segment that is tapered in a nozzle flow direction of the injector nozzle and fluidly connected to the first distal end of the first nozzle segment; and a second tapered nozzle segment that is tapered in a direction opposite the nozzle flow direction and fluidly connected to a distal end of the first tapered nozzle segment, and wherein a connection point between the distal end of the first tapered nozzle segment and a proximal end of the second tapered nozzle segment defines a throat of the injector nozzle.

A ninth aspect includes any one of the first through fifth aspects, wherein each injector nozzle comprises a first tapered nozzle segment that is tapered in a nozzle flow direction of the injector nozzle.

A tenth aspect includes the ninth aspect, wherein each injector nozzle further comprises a second tapered nozzle segment that is tapered in a direction opposite the nozzle flow direction and fluidly connected to a distal end of the first tapered nozzle segment, and wherein a connection point between the distal end of the first tapered nozzle segment and a proximal end of the second tapered nozzle segment defines a throat of the injector nozzle.

An eleventh aspect includes any one of the first through tenth aspects, wherein one or more of the nozzle tips are open-ended.

A twelfth aspect includes any one of the first through eleventh aspects, wherein one or more of the nozzle tips comprises a catalyst distributor plate comprising a plurality of holes.

A thirteenth aspect includes the twelfth aspect, wherein the plurality of holes comprises: a central hole having a central hole diameter HD_{C}; and a plurality of radial holes equidistant from the central hole and having a radial hole diameter HD_{R} that is less than the central hole diameter HD_{C}, wherein the plurality of radial holes are axisymmetric about the nozzle axis A_{N}.

A fourteenth aspect includes any one of the first through thirteenth aspects, wherein the method further comprises injecting carrier gas into each injector nozzle.

A fifteenth aspect includes the fourteenth aspect, wherein carrier gas is injected into each injector nozzle through a plurality of carrier gas injectors coupled to a circumferential wall of the injector nozzle and having an injector axis A_{I} that forms an angle α with the nozzle axis A_{N}.

A sixteenth aspect includes the fifteenth aspect, wherein the plurality of carrier gas injectors comprises: a first set of carrier gas injectors coupled to the circumferential wall of the injector nozzle at a fourth distance from the nozzle end plane P_{E} along the nozzle axis A_{N}; a second set of carrier gas injectors coupled to the circumferential wall of the injector nozzle at a fifth distance from the nozzle end plane P_{E} along the nozzle axis A_{N}, wherein the fifth distance is greater than the fourth distance.

A seventeenth aspect includes any one of the first through sixteenth aspects, wherein each injector nozzle further comprises a carrier gas distribution chamber surrounding a central passageway of the injector nozzle and separated from the central passageway by a perforated inner wall.

According to an eighteenth aspect of the present disclosure, a fluidized catalytic cracking (FCC) system comprises: a reactor vessel comprising an elongated reaction tube having a substantially vertical orientation, a top end, and a bottom end; a hydrocarbon feed inlet proximate the bottom end of the reactor vessel; a catalyst injection system proximate the top end of the reactor vessel, wherein the catalyst injection system comprises a plurality of injector nozzles, and wherein one or more of the injector nozzles of the plurality of injector nozzles comprises: a nozzle axis A_{N}; a nozzle tip defining a nozzle end plane P_{E} that is normal to the nozzle axis A_{N}; a first inner diameter ID₁ at a first distance D₁ from the nozzle end plane P_{E} along the nozzle axis A_{N}; a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁; and a downwards elevation angle Φ of at most 60 degrees between the nozzle axis A_{N} and a longitudinal axis A_{L} of the reactor vessel.

A nineteenth aspect includes the eighteenth aspect, wherein: each injector nozzle comprises: a nozzle tip radius R_{T}; and a nozzle projected axis A_{NP}, wherein the nozzle projected axis A_{NP} is a projection of the nozzle axis A_{N} on a plane P normal to the longitudinal axis A_{L} of the reactor vessel; and each injector nozzle is positioned such that its nozzle projected axis A_{NP} intersects a radius normal R_{N} of the reactor vessel at a distance from the longitudinal axis A_{L} that is greater than 0.1×R_{N} and less than or equal to R_{N}−R_{T}.

A twentieth aspect includes either one of the eighteenth or nineteenth aspects, wherein each injector nozzle comprises: a first nozzle segment having the first inner diameter ID₁ and comprising a first proximal end and a first distal end; a second nozzle segment having the second inner diameter ID₂ and comprising a second proximal end and a second distal end; and a first tapered connector interposed between the first nozzle segment and the second nozzle segment and fluidly connecting the first proximal end of the first nozzle segment to the second distal end of the second nozzle segment.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C.

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butylene may include a mixture of various isomers of butylene. It should be appreciated that the examples supply compositional ranges for various streams, and that the total amount of isomers of a particular chemical composition can constitute a range.

1. A method for processing hydrocarbons, the method comprising:
introducing a hydrocarbon feed stream into a reactor vessel through a hydrocarbon feed inlet proximate a bottom end of the reactor vessel;
introducing a catalyst into the reactor vessel through a catalyst injection system proximate a top end of the reactor vessel, wherein the catalyst injection system comprises a plurality of injector nozzles, and wherein one or more injector nozzles of the plurality of injector nozzles comprises:
a nozzle axis A_{N};
a nozzle tip defining a nozzle end plane P_{E} that is normal to the nozzle axis A_{N};
a first inner diameter ID₁ at a first distance D₁ from the nozzle end plane P_{E} along the nozzle axis A_{N};
a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁; and
a downwards elevation angle Φ of at most 60 degrees between the nozzle axis A_{N} and a longitudinal axis A_{L} of the reactor vessel; and
contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone.

2. The method of claim 1, wherein the nozzle axis A_{N} of each injector nozzle intersects the longitudinal axis A_{L} of the reactor vessel.

3. The method of claim 2, wherein the plurality of injector nozzles comprises at least four injector nozzles equally spaced about a circumference of the reactor vessel.

4. The method of claim 1, wherein:
each injector nozzle comprises:
a nozzle tip radius R_{T}; and
a nozzle projected axis A_{NP}, wherein the nozzle projected axis A_{NP} is a projection of the nozzle axis A_{N} on a plane P normal to a longitudinal axis A_{L} of the reactor vessel; and
each injector nozzle is positioned such that its nozzle projected axis A_{NP} intersects a radius normal R_{N} of the reactor vessel at a distance from the longitudinal axis A_{L} that is greater than or equal to 0.1×R_{N} and less than or equal to R_{N}−R_{T}.

5. The method of claim 4, wherein the plurality of injector nozzles comprises two injector nozzles positioned on opposite sides of a cross-section of the reactor vessel.

6. The method of claim 1, wherein each injector nozzle comprises:
a first nozzle segment having the first inner diameter ID₁ and comprising a first proximal end and a first distal end;
a second nozzle segment having the second inner diameter ID₂ and comprising a second proximal end and a second distal end; and
a first tapered connector interposed between the first nozzle segment and the second nozzle segment and fluidly connecting the first proximal end of the first nozzle segment to the second distal end of the second nozzle segment.

7. The method of claim 6, wherein each injector nozzle further comprises:
a third nozzle segment having a third inner diameter ID₃ and comprising a third proximal end and a third distal end; and
a second tapered connector interposed between the second nozzle segment and the third nozzle segment and fluidly connecting the second proximal end of the second nozzle segment to the third distal end of the third nozzle segment, wherein the third inner diameter ID₃ is greater than the second inner diameter ID₂.

8. The method of claim 6, wherein each injector nozzle further comprises:
a first tapered nozzle segment that is tapered in a nozzle flow direction of the injector nozzle and fluidly connected to the first distal end of the first nozzle segment; and
a second tapered nozzle segment that is tapered in a direction opposite the nozzle flow direction and fluidly connected to a distal end of the first tapered nozzle segment, and wherein a connection point between the distal end of the first tapered nozzle segment and a proximal end of the second tapered nozzle segment defines a throat of the injector nozzle.

9. The method of claim 1, wherein each injector nozzle comprises a first tapered nozzle segment that is tapered in a nozzle flow direction of the injector nozzle.

10. The method of claim 9, wherein each injector nozzle further comprises a second tapered nozzle segment that is tapered in a direction opposite the nozzle flow direction and fluidly connected to a distal end of the first tapered nozzle segment, and wherein a connection point between the distal end of the first tapered nozzle segment and a proximal end of the second tapered nozzle segment defines a throat of the injector nozzle.

11. The method of claim 1, wherein one or more of the nozzle tips are open-ended.

12. The method of claim 1, wherein one or more of the nozzle tips comprises a catalyst distributor plate comprising a plurality of holes.

13. The method of claim 12, wherein the plurality of holes comprises:
a central hole having a central hole diameter HD_{C}; and
a plurality of radial holes equidistant from the central hole and having a radial hole diameter HD_{R} that is less than the central hole diameter HD_{C}, wherein the plurality of radial holes are axisymmetric about the nozzle axis A_{N}.

14. The method of claim 1, further comprising injecting carrier gas into each injector nozzle.

15. The method of claim 14, wherein carrier gas is injected into each injector nozzle through a plurality of carrier gas injectors coupled to a circumferential wall of the injector nozzle and having an injector axis A_{I} that forms an angle α with the nozzle axis A_{N}.

16. The method of claim 15, wherein the plurality of carrier gas injectors comprises:
a first set of carrier gas injectors coupled to the circumferential wall of the injector nozzle at a fourth distance from the nozzle end plane P_{E} along the nozzle axis A_{N};
a second set of carrier gas injectors coupled to the circumferential wall of the injector nozzle at a fifth distance from the nozzle end plane P_{E} along the nozzle axis A_{N}, wherein the fifth distance is greater than the fourth distance.

17. The method of claim 14, wherein each injector nozzle further comprises a carrier gas distribution chamber surrounding a central passageway of the injector nozzle and separated from the central passageway by a perforated inner wall.

18. A fluidized catalytic cracking (FCC) system comprising:
a reactor vessel comprising an elongated reaction tube having a substantially vertical orientation, a top end, and a bottom end;
a hydrocarbon feed inlet proximate the bottom end of the reactor vessel;
a catalyst injection system proximate the top end of the reactor vessel, wherein the catalyst injection system comprises a plurality of injector nozzles, and wherein one or more of the injector nozzles of the plurality of injector nozzles comprises:
a nozzle axis A_{N};
a nozzle tip defining a nozzle end plane P_{E} that is normal to the nozzle axis A_{N};
a first inner diameter ID₁ at a first distance D₁ from the nozzle end plane P_{E} along the nozzle axis A_{N};
a second inner diameter ID₂ at a second distance D₂ from the nozzle end plane P_{E} along the nozzle axis A_{N}, wherein the second distance D₂ is greater than the first distance D₁, and wherein the second inner diameter ID₂ is greater than the first inner diameter ID₁; and
a downwards elevation angle Φ of at most 60 degrees between the nozzle axis A_{N} and a longitudinal axis A_{L} of the reactor vessel.

19. The FCC system of claim 18, wherein:
each injector nozzle comprises:
a nozzle tip radius R_{T}; and
a nozzle projected axis A_{NP}, wherein the nozzle projected axis A_{NP} is a projection of the nozzle axis A_{N} on a plane P normal to the longitudinal axis A_{L} of the reactor vessel; and
each injector nozzle is positioned such that its nozzle projected axis A_{NP} intersects a radius normal R_{N} of the reactor vessel at a distance from the longitudinal axis A_{L} that is greater than 0.1×R_{N} and less than or equal to R_{N}−R_{T}.

20. The FCC system of claim 18, wherein each injector nozzle comprises:
a first nozzle segment having the first inner diameter ID₁ and comprising a first proximal end and a first distal end;
a second nozzle segment having the second inner diameter ID₂ and comprising a second proximal end and a second distal end; and
a first tapered connector interposed between the first nozzle segment and the second nozzle segment and fluidly connecting the first proximal end of the first nozzle segment to the second distal end of the second nozzle segment.
